(19) United States
(12) Patent Application Publication
(10) Pub. No.: US 2014/0124658 A1
(43) Pub. Date: May 8, 2014

(54) GATE CONTROLLER MECHANISM

(71) Applicant: Michael Xie, Ontario, CA (US)

(72) Inventor: Michael Xie, Ontario, CA (US)

(73) Assignee: Platinum Access Systems Inc.

(21) Appl. No.: 13/669,660

(22) Filed: Nov. 6, 2012

(51) Int. Cl. G01J 1/04

(52) U.S. Cl. 250/236

(57) ABSTRACT

A gate controller mechanism includes a housing, a shaft mounted to the housing, a shaft screw thread formed on the shaft, a first limit wheel having a first limit wheel notch and having a first limit wheel threading engaging with the shaft screw thread, a second limit wheel having a second limit wheel notch and having a second limit wheel threading engaging with the shaft screw thread, a rail edge mounted to the housing and engaging into the first limit wheel notch and engaging into the second limit wheel notch, a first switch actuated by the first limit wheel, and a second switch actuated by the second limit wheel. The first limit wheel notch and the second limit wheel notch slide along the rail edge when the shaft rotates.

### FIELD OF THE INVENTION

The present invention is in the field of electromechanical gate controllers.

### DISCUSSION OF RELATED ART

A variety of different mechanisms can be used for electromechanical gate controlling. Many of these have different types of mechanisms. For example, in U.S. Pat. No. 575,753, issued Jan. 26, 1897, inventor Carlson creates a mechanical gate-controller for an elevator, which allows an elevator to have self-closing gates. In U.S. Pat. No. 4,416,085, issued Nov. 22, 1983, inventors Lybecker et al. creates a gate that is able to open automatically by means of a hydraulic cylinder. In circumstances where electricity is not readily available, the gate can be powered by a solar panel or from a traditional batter charger.

Electromechanical control systems are typically used for gate control and can embody a wide variety of different types of techniques for adjusting travel distance, stopping positions and travel speed. In U.S. Pat. No. 5,323,151, issued Jun. 21, 1994, inventor Parsadayan describes an electrical gate that functions through a quick close circuit. It is the quick close circuit that allows vehicles through the gate by opening the gate. It is also the same circuit that allows the gate from further opening once the vehicle has passed the entrance, and instead, begins closing the gate. In United States Patent 2006/0071553, issued Apr. 6, 2006, inventor Lengacher et al. creates a lift gate power control system. This system is electrically operated and involves an electrical unit with a storage battery that allows for raising and lowering of the lift gate.

### SUMMARY OF INVENTION

A gate controller mechanism includes a housing, a shaft mounted to the housing, a shaft screw thread formed on the shaft, a first limit wheel having a first limit wheel notch and having a first limit wheel threading engaging with the shaft screw thread, a second limit wheel having a second limit wheel notch and having a second limit wheel threading engaging with the shaft screw thread, a rail edge mounted to the housing and engaging into the first limit wheel notch and engaging into the second limit wheel notch, a first switch actuated by the first limit wheel, and a second switch actuated by the second limit wheel. The first limit wheel notch and the second limit wheel notch slide along the rail edge when the shaft rotates.

Rail mounting apertures receive rail mounting bolts. The rail mounting bolts connect the rail to the housing. A first limit wheel notch and a second limit wheel notch slide along the rail edge in the same direction when the shaft rotates.

The optical sensor senses rotation of an optical wheel, and the optical wheel has optical wheel prongs and optical wheel gaps between the optical wheel prongs. The optical wheel passes through an optical sensor beam allowing the optical sensor beam to output a rotational signal. The first limit wheel has a extra first limit wheel notches and the second limit wheel has extra second limit wheel notches. The first switch has a first switch arm actuated by the first limit wheel and the second switch has a second switch arm actuated by the second limit wheel.

The gate controller mechanism may also further include a rail extension upon which the rail edge is formed. Preferably, the rail extension extends from a fulcrum. A first bearing mount can be formed as a first aperture on the housing and a second bearing mount can be formed as a second aperture on the housing. The first bearing mount receives a first shaft bearing, and the second bearing mount receives a second shaft bearing. A first end of the shaft is mounted to the first bearing mount and a second end of the shaft is mounted to the second bearing mount.

### BRIEF DESCRIPTION OF THE DRAWINGS

FIG. 1 is an assembled view of the present invention with a cover removed for showing internal components of the controller.

FIG. 2 is an exploded view of the present invention.

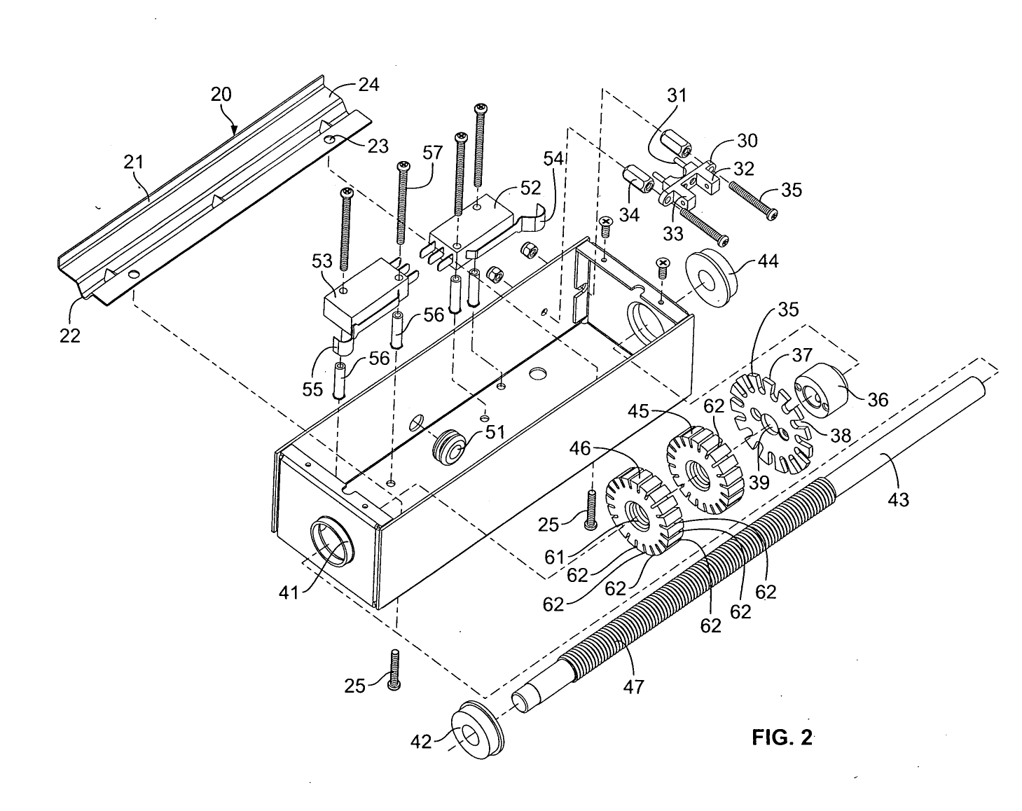

The following call out list of elements is a useful guide in referencing the call out numbers of the drawings.
20 Rail
21 Rail Edge
22 Rail Fulcrum
23 Rail Mounting Aperture
24 Rail Extension
25 Rail Mounting Bolt
30 Optical Sensor
31 Optical Senso Wire Lead
32 Emitter
33 Receiver
34 Riser Nut
35 Optical Sensor Mounting Bolt
135 Optical Wheel
36 Optical Wheel Coupler
37 Optical Wheel Prong
38 Optical Wheel Gap
39 Optical Wheel Shaft Mount
41 Bearing Mount
42 First Shaft Bearing
43 Main Shaft
44 Second Shaft Bearing
45 First Limit Wheel
46 Second Limit Wheel
47 Shaft Screw Thread
51 Wire Harness Grommet
52 First Switch
53 Second Switch
54 First Switch Arm
55 Second Switch Arm
56 Switch Riser Nut
57 Switch Bolt
61 Limit Wheel Threading
62 Limit Wheel Notch

### DETAILED DESCRIPTION OF THE PREFERRED EMBODIMENTS

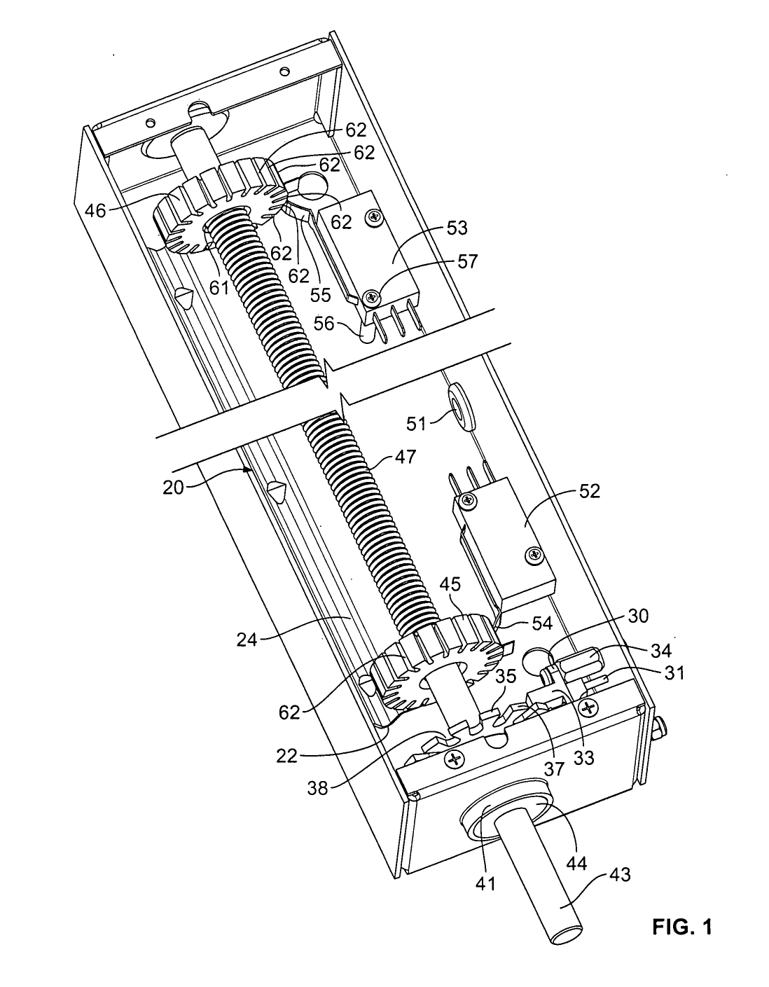

FIG. 1 is a split view with the top portion of the figure describing the position when the top wheel hits its switch and with the bottom portion of the figure describing when the bottom wheel hits the switch. It is known to a person of ordinary skill in the art that the other wheel would be somewhere more toward the middle when one wheel is toward the end. This is in the usual case where travel distances are normal. In a short travel distance situation, the wheels would be further apart and in a long travel distance situation, the wheels would be closer together. The wheels can be manually adjusted and are designed for ease of finger manipulation.

A rail 20 has a rail edge 21 and that is mounted on a rail fulcrum 22. The rail fulcrum is for the rail that is mounted as a lever on rail mounting apertures 23 disposed through a thickness of the rail 20. The rail mounting apertures may receive rail mounting bolts having coil or leaf springs that bias the rail. Alternatively, a separate the spring can bias the rail on the fulcrum to keep the rail edge engaged. The rail 20 is formed of a flat sheet of metal preferably. With the rail mounting apertures pushed downward being secured to a housing, the rail fulcrum pushes the rail edge 21 upward. Springs can be included on the rail mounting bolts 25 for providing resilient downward force on the rail mounting apertures so as to provide an upward force on a rail extension 24. The rail extension extends a distance away from the rail fulcrum and terminates in an upward rail edge.

An optical sensor 30 is electrically connected to the control circuit and has electrical leads for outputting an optical sensor signal. The optical sensor signal is generated when the shaft is rotating. The optical sensor has optical sensor wire leads 31 that can be soldered to or otherwise receive signal wires. The optical sensor 30 is comprised of an emitter 32 that may provide an infrared light or visible light which is seen by a receiver 33. The optical sensor is mounted to the housing by a riser nut 34. The optical sensor mounting bolt 35 secures the optical sensor to the riser nut 34. The riser nut is mounted to the housing at a side wall of the housing which can be by a nut or a bolt.

The optical sensor sees an optical wheel 135 and monitors the rotation of the optical wheel. The optical wheel prong 37 extends outwardly from an optical wheel gap 38. The optical wheel gap alternates with the optical wheel prong 37 so that the optical sensor is activated intermittently at a frequency corresponding to and proportional to the rate of rotation of the main shaft 43.

The optical wheel is mounted to an optical wheel shaft mount 39. The optical wheel shaft mount 39 is an opening sized so that the main shaft passes through the optical wheel shaft mount. The optical wheel is mounted to an optical wheel coupler 36. The optical wheel coupler can be connected to the optical wheel by a pair of bolts passing through a face of the optical wheel and into the optical wheel coupler. The optical wheel coupler can then be connected to the main shaft by a set screw set within the optical wheel coupler. The set screw is accessible from an external surface of the optical wheel coupler and passes through the surface of the optical wheel coupler so that the set screw engages to an outside surface of the main shaft to secure the optical wheel coupler to the main shaft. The optical wheel is preferably connected to a smooth portion of the main shaft and is preferably not connected to the screw shaft thread of the main shaft.

The main shaft 43 is mounted to a bearing mount 41 of the housing. The housing is preferably formed as a metal box having a pair of coaxial round openings with flanges. A first bearing mount 41 is an opening formed on one side of the housing and a second bearing mount is formed on the other side of the housing. A first shaft bearing 42 can be inserted into the first bearing mount and a second shaft bearing 44 can be inserted into the second bearing mount.

The shaft screw thread 47 is formed on the main shaft 43 and receives a first limit wheel 45 and the second limit wheel 46. The first limit wheel 45 is spaced a set distance from the second limit wheel 46. The limit wheels are a pair with one limit wheel assigned for the starting position and with the second limit wheel assigned for the ending position of the gate. The limit wheels spin on the shaft screw thread so that the rotation of the shaft screw thread pushes the limit wheels in a translation motion. The limit wheels do not rotate because they are retained on the rail edge 21.

As the main shaft rotates, the limit wheel threading 61 engages with the screw shaft thread. The limit wheel notch 62 engages with the rail 20. Preferably, a plurality of limit wheel notches are implemented so that any one of them can be inserted into the rail 20. The limit wheel notch 62 slides along the rail 20 back and forth as the gate is opened and closed. The screw shaft thread 47 rotates relative to the limit wheel threading 61 as the gate is opened and closed. The shaft can also have different sections of shaft screw thread that have opposite orientation so that the first limit wheel and the second limit wheel move in opposite directions when the shaft rotates. It is preferred that the shaft has the same orientation so that the first limit wheel and the second limit wheel moves in the same direction when the shaft rotates.

A wire harness is electrically connected to a first switch 52 and a second switch 53 as well as the optical sensor. The wire harness passes through a wire harness grommet 51. The wire harness grommet is preferably made of an elastomeric material and press fitted into a side wall of the housing. The side wall of the housing preferably has an opening for receiving the wire harness grommet formed as an annular member. The first switch 52 has a first switch arm 54 that is depressed when the first limit wheel is pushed to contact and press the first switch arm. The first switch arm is mounted to the housing preferably by a switch riser nut 56 and connected to the housing by a switch bolt 57 which can be inserted through the external surface of the housing, or in an opposite matter from the inside of the housing to the outset of housing.

The second switch 53 as a second switch arm 55 that can be depressed by the second limit wheel 46. The second limit wheel 46 provides a pushing force to depress the second switch arm 55. The control circuitry used can be standard control circuitry for gate opening devices.

The gate controller mechanism has a variety of different possible installations which is flexible. For example, the shaft can be connected to a sprocket that drives a chain which is connected to a sliding gate that opens and closes. The gate opener can also be attached to other mechanisms that are not sliding gates.

1. A gate controller mechanism comprising:
a. a housing;
b. an optical sensor sensing rotation of an optical wheel, wherein the optical wheel has optical wheel prongs and optical wheel gaps between the optical wheel prongs, wherein the optical wheel passes through an optical sensor beam allowing the optical sensor beam to output a rotational signal.

2. The gate controller mechanism of claim 1, further comprising:
a. a shaft mounted to the housing;
b. shaft screw thread formed on the shaft;
c. a first limit wheel having a first limit wheel notch and having a first limit wheel threading engaging with the shaft screw thread;
d. a second limit wheel having a second limit wheel notch and having a second limit wheel threading engaging with the shaft screw thread;
e. a rail edge mounted to the housing and engaging into the first limit wheel notch and engaging into the second limit wheel notch, wherein first limit wheel notch and the second limit wheel notch slide along the rail edge when the shaft rotates;
f. a first switch actuated by the first limit wheel; and
g. a second switch actuated by the second limit wheel.

3. The gate controller mechanism of claim 2, further comprising: rail mounting apertures for receiving rail mounting bolts, wherein the rail mounting bolts connect the rail to the housing.

4. The gate controller mechanism of claim 2, wherein first limit wheel notch and the second limit wheel notch slide along the rail edge in the same direction when the shaft rotates.

5. The gate controller mechanism of claim 2, wherein first limit wheel has a plurality of extra first limit wheel notches and the second limit wheel has a plurality of extra second limit wheel notches.

6. The gate controller mechanism of claim 2, wherein the first switch has a first switch arm actuated by the first limit wheel and wherein the second switch has a second switch arm actuated by the second limit wheel.

7. The gate controller mechanism of claim 2, further comprising: a rail extension upon which the rail edge is formed, wherein the rail extension extends from a fulcrum.

8. The gate controller mechanism of claim 7, further comprising: rail mounting apertures for receiving rail mounting bolts, wherein the rail mounting bolts connect the rail to the housing.

9. The gate controller mechanism of claim 7, wherein first limit wheel notch and the second limit wheel notch slide along the rail edge in the same direction when the shaft rotates.

10. The gate controller mechanism of claim 7, wherein first limit wheel has a plurality of extra first limit wheel notches and the second limit wheel has a plurality of extra second limit wheel notches.

11. The gate controller mechanism of claim 7, wherein the first switch has a first switch arm actuated by the first limit wheel and wherein the second switch has a second switch arm actuated by the second limit wheel.

12. The gate controller mechanism of claim 7, further comprising a first bearing mount formed as a first aperture on the housing and further comprising a second bearing mount formed as a second aperture on the housing, wherein the first bearing mount receives a first shaft bearing, wherein the second bearing mount receives a second shaft bearing, wherein a first end of the shaft is mounted to the first bearing mount and wherein a second end of the shaft is mounted to the second bearing mount.

13. The gate controller mechanism of claim 12, further comprising: rail mounting apertures for receiving rail mounting bolts, wherein the rail mounting bolts connect the rail to the housing.

14. The gate controller mechanism of claim 12, wherein first limit wheel notch and the second limit wheel notch slide along the rail edge in the same direction when the shaft rotates.

15. The gate controller mechanism of claim 14, wherein first limit wheel has a plurality of extra first limit wheel notches and the second limit wheel has a plurality of extra second limit wheel notches.

16. The gate controller mechanism of claim 14, wherein the first switch has a first switch arm actuated by the first limit wheel and wherein the second switch has a second switch arm actuated by the second limit wheel.
